(19) United States
(12) Patent Application Publication
(10) Pub. No.: US 2009/0013550 A1
(43) Pub. Date: Jan. 15, 2009

(54) Lightweight patio block ground preparation aid

(76) Inventors: Gregory Andrew Kaczmarz, Winnipeg (CA); Bruce M. Kisell, Winnipeg (CA)

Correspondence Address: Gregory Kaczmarz, 3 Savile Ave., Winnipeg, MB, R3R 2T4, CA

(21) Appl. No.: 11/826,051

(22) Filed: Jul. 12, 2007

(51) Int. Cl. G01B 1/00; E01C 5/00

(52) U.S. Cl. 33/526; 52/223.7

(57) ABSTRACT

A lightweight patio block used in the preparation of the ground for the placement of a heavier, real patio block is disclosed. Laying flat on the ground, the top of the lightweight patio block has an opening near each edge (4 openings total) that act as handles. The handles allow the user to easily maneuver the object and manipulate the ground below. Two bubble levels placed at 90 degrees to each other in an opening below the surface allow the levelness of the ground to be checked across both the length and width, at a glance. There is a ruled line near each of two adjacent edges (2 ruled lines total) to help with the positioning of the lightweight patio block and/or other objects relative to the lightweight patio block.

### BACKGROUND OF THE INVENTION

This invention relates to the field of landscaping, specifically tools used in the preparation of the ground for placement of patio blocks. A patio block is typically very heavy and often needs to be placed numerous times in the desired location due to the difficulty of preparing the ground properly for the patio block. This invention was conceived when a method was sought to reduce the effort required to properly place heavier patio blocks.

### BRIEF SUMMARY OF THE INVENTION

A lightweight patio block is described that is equal in dimensions (length, width, and height) to a patio block, but much lighter to help with the preparation of the ground prior to the heavier, real patio block being placed. The lightweight patio block would be made from a lightweight material, and would be available in a variety of sizes common for heavier, real patio blocks.

Laying flat on the ground, the top of the lightweight patio block has an opening near each edge (4 openings total). These openings act as handles and allow the user to easily maneuver the object.

Laying flat on the ground, the top of the lightweight patio block has an opening in the center that will support two bubble levels just below the surface at 90 degrees to each other. The two are placed at 90 degrees to each other such that the levelness of the ground can be checked across both the width and length, at a glance, without having to use a typical level.

Laying flat on the ground, the top of the lightweight patio block has a ruled line near each of two adjacent edges (2 ruled lines total). These ruled lines will help with the positioning of the lightweight patio block and/or other objects relative to the lightweight patio block.

The invention will help the user avoid having to reposition the heavier, real patio block numerous times due to the ground not being properly prepared. Applications include, among other things, sidewalks, patios, driveways, small building foundations, stairs, and deck supports.

### BRIEF DESCRIPTION OF THE SEVERAL VIEWS OF THE DRAWING

FIG. 1 is a top view of the lightweight patio block (while the lightweight patio block is lying on the ground) showing recessed handles, bubble levels placed within an opening in the top of the lightweight patio block, and ruled lines.

FIG. 2 is a side view of the lightweight patio block.

### DETAILED DESCRIPTION OF THE INVENTION

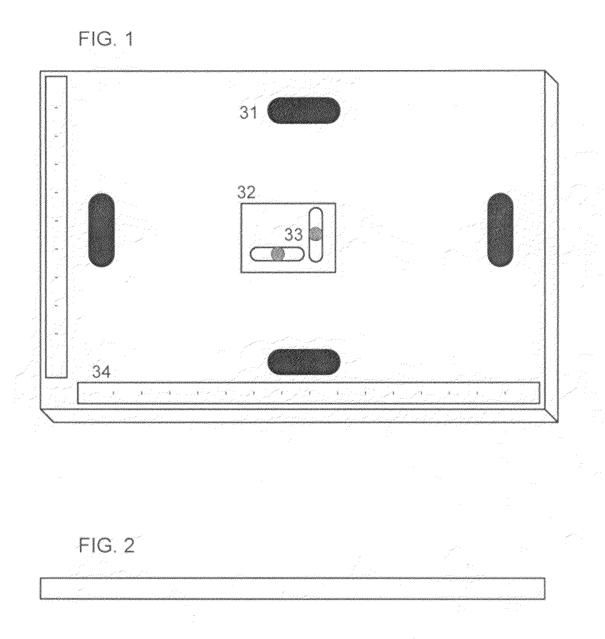

FIG. 1 shows a lightweight patio block that is equal in dimensions (length, width, and height) to a patio block, but much lighter to help with the preparation of the ground prior to the heavier, real patio block being placed. The lightweight patio block would be made from a lightweight material, and would be available in a variety of sizes common for heavier, real patio blocks.

Referring to FIG. 1, a lightweight patio block includes four openings in the surface that act as handles 31, two bubble levels 33 placed below the surface in a cavity 32, and two ruled lines 34.

The handles 31 make it easy for the user to maneuver the lightweight patio block, apply downward force, and shift the unit from side to side thus leveling the ground underneath. This makes it much easier to properly place the heavier, real patio block.

The two bubble levels placed at 90 degrees allow the user to determine the levelness of the lightweight patio block in all directions, at once, without having to use an external level. In some cases, using an external level is not possible due to tight spaces. In addition, the bubble levels are recessed into the surface in a cavity 32 such that the user can stand on the unit without breaking the bubble levels.

The ruled lines 34 allow the user to determine the lightweight patio block's position relative to other objects without the aid of an external measuring device.

FIG. 2 is a view of the lightweight patio block from the side. There are no protrusions of note.

The invention will help the user avoid having to reposition the heavier, real patio block numerous times due to the ground not being properly prepared. Applications include, among other things, sidewalks, patios, driveways, small building foundations, stairs, and deck supports.

1. A lightweight patio block that comprises: four holes on the top of the lightweight patio block (when the lightweight patio block is lying flat on the ground) placed near the four edges and acting as handles, two bubble levels placed at 90 degrees to each other in the center of the lightweight patio block (when the lightweight patio block is lying flat on the ground) and recessed into the surface, and two ruled lines on the top of the lightweight patio block (when the lightweight patio block is lying flat on the ground) placed near two adjacent edges between the handles and the actual edges of the lightweight patio block.

2. The lightweight patio block of claim 1 wherein the lightweight patio block is made from a lightweight material.

3. The lightweight patio block of claim 1 wherein the lightweight patio block is available in a variety of sizes common to heavier, real patio blocks.
